(19) United States
(12) Patent Application Publication
(10) Pub. No.: US 2026/0229602 A1
(43) Pub. Date: Aug. 6, 2026

(54) SOLID-STATE BATTERY

(71) Applicant: TOYOTA JIDOSHA KABUSHIKI KAISHA, Toyota-shi (JP)

(72) Inventors: Yuki SATO, Nagakute-shi (JP); Hideyuki TOKIOKA, Toyota-shi (JP); Kenichi KAKISHITA, Nagoya-shi (JP); Takuya KIMURA, Toyota-shi (JP); Tetsuya WASEDA, Toyota-shi (JP); Takuya MATSUYAMA, Miyoshi-shi (JP)

(73) Assignee: TOYOTA JIDOSHA KABUSHIKI KAISHA, Toyota-shi (JP)

(21) Appl. No.: 19/345,257

(22) Filed: Sep. 30, 2025

(30) Foreign Application Priority Data
Feb. 6, 2025 (JP) 2025-018795

(51) Int. Cl. H01M 10/058

(52) U.S. Cl. CPC H01M 10/058

(57) ABSTRACT

The present disclosure relates to a solid-state battery. The solid-state battery includes a cathode active material layer and a solid electrolyte layer adjacent to the cathode active material layer. A surface development ratio (Sdr) of a surface of the cathode active material layer near the solid electrolyte layer is 0.070 or more.

### CROSS-REFERENCE TO RELATED APPLICATION

This application claims priority to Japanese Patent Application No. 2025-018795 filed on Feb. 6, 2025. The disclosure of the above-identified application, including the specification, drawings, and claims, is incorporated by reference herein in its entirety.

### BACKGROUND

### 1. Technical Field

The present disclosure relates to a solid-state battery.

### 2. Description of Related Art

In recent years, demand for secondary batteries has been increasing, and in addition to secondary batteries that include an electrolyte solution, development of solid-state batteries using solid electrolytes has been actively pursued. An all-solid-state battery, which is an example of a solid-state battery, is a battery that includes a solid electrolyte layer in place of a liquid electrolyte. Since it does not use a flammable organic solvent, the safety system can be simplified, resulting in reduced manufacturing cost and improved productivity.

As a method for manufacturing an all-solid-state battery having a higher energy density while pressing the layers constituting the all-solid-state battery with less cracking, there is known a method for manufacturing an all-solid-state battery in which the surface of at least one layer out of a cathode active material layer, a solid electrolyte layer, and an anode active material layer is pressed into an uneven shape, the layers are laminated such that the surface having the uneven shape is in contact with the other layers, and the laminate is pressed such that the layer pressed into the uneven shape has a flat plate shape (see Japanese Unexamined Patent Application Publication No. 2017-84609 (JP 2017-84609 A)).

### SUMMARY

In solid-state batteries, it is desirable to further improve the battery performance by improving the joining state of layers in the solid-state battery.

An object of one embodiment of the present disclosure is to provide a solid-state battery with a good joining state of a cathode active material layer and a solid electrolyte layer.

Means for achieving the above object include the following aspects.
<1> A solid-state battery including a cathode active material layer and a solid electrolyte layer adjacent to the cathode active material layer, in which a surface development ratio (Sdr) of a surface of the cathode active material layer near the solid electrolyte layer is 0.070 or more.
<2>A solid-state battery including a cathode active material layer and a solid electrolyte layer adjacent to the cathode active material layer, in which a surface peak curvature (Spc) of a surface of the cathode active material layer near the solid electrolyte layer is 4900 or more.
<3>A solid-state battery including a cathode active material layer and a solid electrolyte layer adjacent to the cathode active material layer, in which an arithmetic mean height (Sa) of a surface of the cathode active material layer near the solid electrolyte layer is 0.12 μm or more.
<4>A solid-state battery including a cathode active material layer and a solid electrolyte layer adjacent to the cathode active material layer, in which a maximum height (Sz) of a surface of the cathode active material layer near the solid electrolyte layer is 1.6 μm or more.
<5>A solid-state battery including a cathode active material layer and a solid electrolyte layer adjacent to the cathode active material layer, in which a surface of the cathode active material layer near the solid electrolyte layer satisfies at least three conditions out of:
a first condition that a surface development ratio (Sdr) of the surface of the cathode active material layer near the solid electrolyte layer is 0.070 or more;
a second condition that a surface peak curvature (Spc) of the surface of the cathode active material layer near the solid electrolyte layer is 4900 or more;
a third condition that an arithmetic mean height (Sa) of the surface of the cathode active material layer near the solid electrolyte layer is 0.12 or more; and
a fourth condition that a maximum height (Sz) of the surface of the cathode active material layer near the solid electrolyte layer is 1.6 μm or more.

According to the embodiment of the present disclosure, it is possible to provide the solid-state battery with a good joining state of the cathode active material layer and the solid electrolyte layer.

### DETAILED DESCRIPTION OF EMBODIMENTS

In the present disclosure, a numerical range expressed using “to” refers to a range inclusive of the values before and after “to” as the minimum and maximum values, respectively.

In numerical ranges described in stages in the present disclosure, the upper or lower limit of one numerical range may be replaced with the upper or lower limit of another numerical range described in stages. In the numerical ranges described in the present disclosure, the upper or lower limit of one numerical range may be replaced with a value indicated in the examples.

In the present disclosure, the term “step” includes not only independent steps but also steps that are not clearly distinguishable from other steps, as long as the intended purpose of the step is achieved.

In the present disclosure, a combination of two or more preferred forms is considered to be a more preferred form.

### Solid-state Battery

A solid-state battery according to one embodiment of the present disclosure includes a cathode active material layer and a solid electrolyte layer adjacent to the cathode active material layer, and a surface of the cathode active material layer near the solid electrolyte layer has a specific uneven shape.

In solid-state batteries, the joint interface between the cathode active material layer and the solid electrolyte layer may have a gap due to contact between solids, a difference in mechanical characteristics of the cathode layer and the solid electrolyte layer, etc. Therefore, it is difficult to obtain a good joining state.

The present inventors have investigated how to obtain a good joining state between the cathode active material layer and the solid electrolyte layer, and have focused on the shape of the surface of the cathode active material layer near the solid electrolyte layer. The present inventors have found that the cathode active material layer and the solid electrolyte layer are satisfactorily joined to each other when the surface of the cathode active material layer near the solid electrolyte layer has a specific uneven shape.

Although the mechanism of the above effect is not clear, it is presumed that the surface of the cathode active material layer having the specific uneven shape exhibits an appropriate anchor effect when the solid electrolyte layer is laminated, and the cathode active material layer and the solid electrolyte layer are tightly bonded to each other without any gap, thereby obtaining a good joining state.

A solid-state battery according to one embodiment of the present disclosure includes a cathode active material layer and a solid electrolyte layer adjacent to the cathode active material layer, and a surface development ratio (Sdr) of a surface of the cathode active material layer near the solid electrolyte layer (hereinafter also referred to as “cathode active material surface”) is 0.070 or more.

The surface development ratio (hereinafter also referred to as “Sdr”) is a parameter indicating how much the developed area of a defined area increases compared to the area of the defined region. For example, a perfectly flat surface has an Sdr of 0, and an Sdr of 0.1 indicates a 10% increase in surface area compared to a flat surface.

In the present disclosure, the Sdr is a value calculated by the following expression (1) after the cathode active material layer is densified in the process of manufacturing the solid-state battery. This involves calculating the actual area in consideration of a slight inclination of the surface and comparing it with the projected area to obtain the Sdr. Specifically, the Sdr is an average of values obtained by calculating the Sdr from a predetermined defined area at five points on the cathode active material surface.

$$\begin{matrix}( Math . 1 ) & \\ {S}_{dr} = \frac{1}{A} [ \int {\int }_{A} ( \sqrt{[ 1 + {( \frac{\partial z ( x , y )}{\partial x} )}^{2} + {( \frac{\partial z ( x , y )}{\partial y} )}^{2} ]} - 1 ) dxdy ] & ( 1 )\end{matrix}$$

In the expression (1), A is a defined area, z(x, y) is a surface height function (function indicating the surface shape), ∂z/∂x and ∂z/∂y are surface gradients (derivatives) in X- and Y-directions, and an integral range A is the defined area on an xy plane.

Specifically, the Sdr calculated by the expression (1) can be calculated using a laser microscope. The laser microscope may be the VK-X3000 series (manufactured by Keyence Corporation) etc.

Alternatively, the Sdr may be measured from an SEM photograph of a cross section cut along the lamination direction after the solid-state battery is manufactured. In this case, the Sdr may be obtained by calculating, in the SEM photograph of the cross section, a specific surface area at the joint interface between the cathode active material layer and the solid electrolyte layer adjacent to the cathode active material layer. Specifically, an Sdr close to the value of the above expression (1) can be obtained from the ratio between the straight line length and the unevenness length on the cathode active material surface obtained using contour data in the SEM photograph. In the process of manufacturing the solid-state battery, the shape of the cathode active material surface at the stage at which the cathode active material layer is densified is likely to be maintained.

In the solid-state battery according to the embodiment of the present disclosure, the Sdr of the cathode active material surface is 0.070 or more, and preferably 0.075 or more. That is, the surface area of the cathode active material surface is larger by 7.0% or more than that of a flat surface. When the Sdr of the cathode active material surface was 0.070 or more, the coverage of the solid electrolyte layer was, for example, 90% or more, and the joining state to the solid electrolyte layer was good. When the coverage of the solid electrolyte layer was less than 90%, the Sdr of the cathode active material surface was 0.062. The coverage of the solid electrolyte layer is herein the ratio of the area of the cathode active material that is in contact with and covers the cathode active material surface to the area of the interface between the cathode active material surface and the solid electrolyte layer.

A solid-state battery according to one embodiment of the present disclosure includes a cathode active material layer and a solid electrolyte layer adjacent to the cathode active material layer, and a surface peak curvature (Spc) of a cathode active material surface is 4900 or more.

The surface peak curvature (hereinafter also referred to as “Spc”) is a parameter indicating an average of principal curvatures of peaks in the unevenness of the surface. As the Spc value increases, the peaks are pointed more. As the Spc value decreases, the peaks are rounded more.

In the present disclosure, the Spc is a value calculated by the following expression (2). Specifically, the Spc is an average of values obtained by calculating the Spc from a predetermined region at five points on the cathode active material surface.

$$\begin{matrix}( Math . 2 ) & \\ {S}_{pk} = - \frac{1}{2 n} {{\sum }_{i = 1}}^{\text{?}} ( \frac{{\partial }^{2} z ( x , y )}{\partial {x}^{2}} + \frac{{\partial }^{2} z ( x , y )}{\partial {y}^{2}} ) & ( 2 )\end{matrix}$$

$$\text{?} \text{indicates text missing or illegible when filed}$$

In the expression (2), n is the number of peaks (peak count), z(x, y) is a function indicating a surface height (3D shape of the surface), ∂z/∂x² and ∂z/∂² are second-order partial derivatives to calculate the surface curvature, and −(1/2n)Σ is a normalization coefficient to determine the average curvature of all the peaks.

Specifically, the Spc calculated by the expression (2) can be calculated using a laser microscope. The laser microscope may be the VK-X3000 series (manufactured by Keyence Corporation) etc.

Alternatively, the Spc may be measured from an SEM photograph of a cross section of the solid-state battery cut along the lamination direction. In this case, an Spc close to the value of the above expression (2) can be obtained by calculating the average curvature of the cross section using contour data of the cathode active material surface at the joint interface between the cathode active material layer and the solid electrolyte layer adjacent to the cathode active material layer in the SEM photograph of the cross section.

In the solid-state battery according to the embodiment of the present disclosure, the Spc of the cathode active material surface is 4900 or more, and preferably 4910 or more. Therefore, in the solid-state battery according to the embodiment of the present disclosure, the uneven shape of the cathode active material surface preferably includes a relatively large number of protrusions with peaks pointed to a certain degree. It is believed that the appropriately pointed peaks on the cathode active material surface improve the anchor effect with the solid electrolyte layer and the interface adhesion is improved. When the Spc of the cathode active material surface was 4900 or more, the coverage of the solid electrolyte layer was, for example, 90% or more, and the joining state to the solid electrolyte layer was good. When the coverage of the solid electrolyte layer was less than 90%, the Spc of the cathode active material surface was 4700.

A solid-state battery according to one embodiment of the present disclosure includes a cathode active material layer and a solid electrolyte layer adjacent to the cathode active material layer, and an arithmetic mean height (Sa) of a cathode active material surface is 0.12 μm or more.

The arithmetic mean height (hereinafter also referred to as “Sa”) is an average of absolute values of differences in height of the unevenness with respect to an average plane of the surface, and is a parameter indicating surface roughness. As the Sa value increases, the cathode active material surface is rougher, and the contact area with the solid electrolyte layer increases. As the Sa value decreases, the cathode active material surface is smoother, and the contact area with the solid electrolyte layer decreases.

In the present disclosure, the Sa is a value calculated by the following expression (3).

$$\begin{matrix}( Math . 3 ) & \\ {S}_{a} = \frac{1}{N} {{\sum }_{i = 1}}^{N} \vert {Z}_{i} \vert & ( 3 )\end{matrix}$$

In the expression (3), N represents the number of measurement points, and Zi represents the height of each measurement point. Specifically, the Sa calculated by the expression (3) can be calculated using a laser microscope. The laser microscope may be the VK-X3000 series (manufactured by Keyence Corporation) etc.

Alternatively, the Sa may be measured from an SEM photograph of a cross section of the solid-state battery cut along the lamination direction. In this case, an Sa close to the value of the above expression (3) can be obtained by calculating the Sa using contour data of the cathode active material surface at the joint interface between the cathode active material layer and the solid electrolyte layer adjacent to the cathode active material layer in the SEM photograph of the cross section.

In the solid-state battery according to the embodiment of the present disclosure, the Sa of the cathode active material surface is 0.12 or more. Therefore, in the solid-state battery according to the embodiment of the present disclosure, the cathode active material surface preferably has a certain degree of roughness, with the average height variation being 0.12 μm or more. When the Sa of the cathode active material surface was 0.12 or more, the coverage of the solid electrolyte layer was, for example, 90% or more, and the joining state to the solid electrolyte layer was good. When the coverage of the solid electrolyte layer was less than 90%, the Sa of the cathode active material surface was 0.10.

A solid-state battery according to one embodiment of the present disclosure includes a cathode active material layer and a solid electrolyte layer adjacent to the cathode active material layer, and a maximum height (Sz) of a surface of the cathode active material layer near the solid electrolyte layer is 1.60 μm or more.

The maximum height of a surface (hereinafter also referred to as “Sz”) is a distance from the highest point to the lowest point on the surface, and is a parameter indicating a difference between the highest point and the lowest point on the surface. As the Sz value increases, the surface has a more extreme unevenness.

In the present disclosure, the Sz is a value calculated by the following expression (4).

$$\begin{matrix}( Math . 4 ) & \\ {S}_{z} = {z}_{max} - {z}_{min} & ( 4 )\end{matrix}$$

In the expression (4), zₘₐₓ is the highest point (peak) in the measurement range, and zₘᵢₙ is the lowest point (valley) in the measurement range. Specifically, the Sz calculated by the expression (4) can be calculated using a laser microscope. The laser microscope may be the VK-X3000 series (manufactured by Keyence Corporation) etc.

Alternatively, the Sz may be measured from an SEM photograph of a cross section of the solid-state battery cut along the lamination direction. In this case, an Sz close to the value of the above expression (4) can be obtained by calculating the Sz using contour data of the cathode active material surface at the joint interface between the cathode active material layer and the solid electrolyte layer adjacent to the cathode active material layer in the SEM photograph of the cross section.

In the solid-state battery according to the embodiment of the present disclosure, the Sz of the cathode active material surface is 1.60 μm or more, and preferably 1.65 μm or more. Therefore, in the solid-state battery according to the embodiment of the present disclosure, the cathode active material surface preferably has a certain degree of deep and high unevenness. When the Sz of the cathode active material surface was 1.60 μm or more, the coverage of the solid electrolyte layer was, for example, 90% or more, and the joining state to the solid electrolyte layer was good. When the coverage of the solid electrolyte layer was less than 90%, the Sz of the cathode active material surface was 1.34 μm.

A solid-state battery according to one embodiment of the present disclosure is preferably a solid-state battery that includes a cathode active material layer and a solid electrolyte layer adjacent to the cathode active material layer, and satisfies at least three conditions out of:
a first condition that a surface development ratio (Sdr) of a surface of the cathode active material layer near the solid electrolyte layer is 0.070 or more;
a second condition that a surface peak curvature (Spc) of the surface of the cathode active material layer near the solid electrolyte layer is 4900 or more;
a third condition that an arithmetic mean height (Sa) of the surface of the cathode active material layer near the solid electrolyte layer is 0.12 or more; and
a fourth condition that a maximum height (Sz) of the surface of the cathode active material layer near the solid electrolyte layer is 1.6 μm or more.

By satisfying at least three conditions out of the first to fourth conditions, the solid-state battery can have a good joining state between the cathode active material layer and the solid electrolyte layer.

The surface development ratio (Sdr), the surface peak curvature (Spc), the arithmetic mean height (Sa), and the maximum height (Sz) are the same as those described above. Any combination of three of the first to fourth conditions preferably represents the shape of the cathode active material surface that is the embodiment of the present disclosure. In the first to fourth conditions, the Sdr and the Sa are related to each other, and the Sdr tends to increase when the Sa increases. Therefore, it is preferable to satisfy three conditions including the first condition, namely the Sdr, or the third condition, namely the Sa. It is more preferable that the solid-state battery according to the embodiment of the present disclosure satisfy the four conditions, namely the first to fourth conditions.

### Method for Manufacturing Cathode Active Material Layer

In the solid-state battery according to the embodiment of the present disclosure, the cathode active material surface can satisfy each of the first to fourth conditions, three conditions out of the first to fourth conditions, or preferably all of the first to fourth conditions, by adjustment of the materials of the cathode active material layer, a method for manufacturing the cathode active material layer, etc.

The materials constituting the cathode active material include a cathode active material, a solid electrolyte, a conductive material, a binder, and a solvent. The cathode active material may be a composite oxide containing lithium and a transition metal (hereinafter also referred to as “composite oxide”). Examples of the composite oxide include a composite oxide having a layered crystal structure, a composite oxide having a spinel crystal structure, and a composite oxide having an olivine crystal structure. The electrode active material contained in the cathode layer may be one kind or a combination of two or more kinds. The cathode active material may be in the form of, for example, fibers, spheres, or flakes.

The volume average particle size of the cathode active material may be selected, for example, from a range of 5 μm to 50 μm. The volume average particle size of the electrode active material is defined as a value (D50) at which the cumulation from the small diameter side reaches 50% in a volume-based particle size distribution obtained by a laser diffraction and scattering method.

Examples of the solid electrolyte include a sulfide solid electrolyte, an oxide solid electrolyte, and a polymer solid electrolyte. From the viewpoint of battery performance, the solid electrolyte is preferably the sulfide solid electrolyte or the polymer solid electrolyte. From the viewpoint of thermal stability, the sulfide solid electrolyte is more preferable. The solid electrolyte may be used alone or in combination of two or more kinds.

Examples of the conductive material include a carbon material, a metal, an oxide that exhibits conductivity, and a nitride that exhibits conductivity. Specific examples of the carbon material include graphite, carbon black (acetylene black, thermal black, furnace black, etc.), a carbon nanotube (CNT), a carbon nanofiber (CNF), and a vapor grown carbon fiber (VGCF, trademark). The conductive material may be used alone or in combination of two or more kinds.

Specific examples of the binder include polyvinylidene fluoride (PVdF), polyethylene, polypropylene, polyethylene terephthalate, cellulose, nitrocellulose, carboxymethyl cellulose, polyethylene oxide, polyepichlorohydrin, polyacrylonitrile, styrene-butadiene rubber (SBR), acrylonitrile-butadiene rubber (NBR), polyacrylate, polymethacrylate, and polytetrafluoroethylene (PTFE).

In the materials for forming the cathode active material layer, each of the first to fourth conditions, three conditions out of the first to fourth conditions, or preferably all of the first to fourth conditions can be satisfied more easily, for example, by containing particles of a plurality of shapes or sizes.

As a method for manufacturing the cathode active material layer, a known method can be adopted. For example, there is a method in which a slurry of the materials for forming the cathode active material layer is applied onto a cathode foil, followed by a densification step.

The densification step is preferably carried out at a relatively low pressure to maintain the shape of the cathode active material surface and to satisfy each of the first to fourth conditions, three conditions out of the first to fourth conditions, or preferably all of the first to fourth conditions, and at a moderate temperature of about 100° C. to 300° C. at which the active material particles undergo partial plastic deformation and the binder flows appropriately.

A manufacturing example will be described below. A cathode slurry was prepared by mixing NCA (78.3 parts by mass) as a cathode active material, SE (18.8 parts by mass), VGCF (2.9 parts by mass), and PVdF (2.8 parts by mass) with a solvent (butyl butyrate). The cathode slurry was applied onto an aluminum foil and dried. Then, the densification step was carried out at 170° C. and about 3 tons to prepare a cathode active material layer. Details of the abbreviated materials are as follows.
SE: sulfide solid electrolyte represented by a composition formula Li₂S-P₂S₅
NCA: cathode active material represented by a composition formula LiNi_{0.8}Co_{0.15}Al_{0.05}O₂
PVdF: polyvinylidene fluoride
VGCF: vapor grown carbon fiber

The cathode active material surface manufactured in the above manufacturing example had a surface development ratio (Sdr) of 0.079 as the first condition, a surface peak curvature (Spc) of 4920, an arithmetic mean height (Sa) of 0.12 μm, and a maximum height (Sz) of 1.65, and thus satisfied all of the first to fourth conditions. When an SEM photograph of a cross section along the lamination direction of a solid-state battery including the cathode active material layer was observed, the shape of the cathode active material surface was maintained, and the coverage of the solid electrolyte layer was 90% or more.

### Type and Application of Battery

The type of the solid-state battery is not particularly limited, but is typically a lithium ion battery. The solid-state battery according to the embodiment of the present disclosure may be a primary battery or a secondary battery, but is preferably the secondary battery. This is because it can repeatedly be charged and discharged, and is useful, for example, as a battery for vehicles. The solid-state battery may be a semi-solid-state battery including a gel layer containing an electrolyte solution and a polymer between an electrode and a solid electrolyte, or may be an all-solid-state battery including a solid electrolyte layer. The solid-state battery is preferably the all-solid-state battery.

The application of the solid-state battery according to the embodiment of the present disclosure is not particularly limited. Typical applications include power supplies for vehicles, electronic devices, and power storage systems. The solid-state battery may be used as a power supply for moving bodies other than vehicles (e.g., trains, ships, and aircraft), or may be used as a power supply for electrical products such as information processing devices. Among these, the solid-state battery according to the embodiment of the present disclosure is preferably used as a power supply for vehicles, and also preferably used as a power supply for driving a hybrid electric vehicle, a plug-in hybrid electric vehicle, or a battery electric vehicle.

Examples of such vehicles include electric four-wheel vehicles, electric two-wheel vehicles, gasoline vehicles, and diesel vehicles. Examples of electric four-wheel vehicles include battery electric vehicles (BEVs), plug-in hybrid electric vehicles (PHEVs), and hybrid electric vehicles (HEVs). Examples of electric two-wheel vehicles include electric motorcycles and electric assist bicycles.

What is claimed is:

1. A solid-state battery comprising a cathode active material layer and a solid electrolyte layer adjacent to the cathode active material layer, wherein
a surface development ratio (Sdr) of a surface of the cathode active material layer near the solid electrolyte layer is 0.070 or more.

2. A solid-state battery comprising a cathode active material layer and a solid electrolyte layer adjacent to the cathode active material layer, wherein
a surface peak curvature (Spc) of a surface of the cathode active material layer near the solid electrolyte layer is 4900 or more.

3. A solid-state battery comprising a cathode active material layer and a solid electrolyte layer adjacent to the cathode active material layer, wherein
an arithmetic mean height (Sa) of a surface of the cathode active material layer near the solid electrolyte layer is 0.12 μm or more.
